(19) United States
(12) Patent Application Publication
(10) Pub. No.: US 2007/0093405 A1
(43) Pub. Date: Apr. 26, 2007

(54) Use of a solution comprising at least one nonionic surfactant

(76) Inventor: Ursula Maier, Bodensee (DE)

Correspondence Address: NATH & ASSOCIATES, 112 South West Street, Alexandria, VA, 22314, US

(21) Appl. No.: 10/578,690

(22) PCT Filed: Nov. 10, 2004
(86) PCT No.: PCT/EP04/12705

§ 371 Date: Oct. 30, 2006

(30) Foreign Application Priority Data
Nov. 10, 2003 (DE) 103 53 310.9

(51) Int. Cl. C11D 17/08

(52) U.S. Cl. 510/421

(57) ABSTRACT

The invention relates firstly to the use of a solution composed of at least one solvent and at least one nonionic surfactant as a carrier system for at least one active substance. The invention secondly provides a composition composed of such a solution with at least one active substance. The nonionic surfactant is preferably an alkylphenoxypolyethoxyethanol. Preferred active substances are washing-active substances, washing composition additives, cosmetic active ingredients, pharmaceutical active ingredients and disinfectants.

The invention relates to the use of solutions of nonionic surfactants and to compositions which comprise such solutions.

Surfactants with their properties known to those skilled in the art are currently finding use in many fields of industry and of daily life. An example of such a use in everyday use is that of products for textile cleaning, for example liquid laundry detergents. In addition to the actual washing-active substances, usually surfactants, further different active substances are typically incorporated into them. Quaternary ammonium compounds function, for example, as textile-softening substances and are supported by water softeners such as phosphonates, gluconates or zeolites. Enzymes, for example, are used selectively against protein- or starch-containing contaminations. Fragrances, optical brighteners and graying inhibitors are just a few further examples of many washing composition additives.

Frequently, however, problems occur in the course of storage and use of washing compositions, especially of liquid washing compositions. Some of the substances incorporated dissolve poorly, phase separation occurs and they separate again even after a short time. The result is opaque, inhomogeneous compositions in which some active constituents are dissolved only partly in the liquid phase, if at all. For reasons of product esthetics, and also for functional reasons, it is, however, desirable to provide to the consumer clear, translucent liquid washing compositions in which all constituents are distributed homogeneously.

A further problem known from everyday life occurs when colored and white textile products are washed together. During the washing operation, the dye molecules become detached from colored items of laundry and enter into new bonds to other textile surfaces. This dye transfer is a well known problem for which various approaches to a solution already exist.

DE 28 28 619 discloses a washing composition which comprises, as a discoloration inhibitor, a composition composed of a nonionic, a zwitterionic and a cationic surfactant. DE 24 20 561 describes a washing composition with discoloration-inhibiting action which is based on an alkali metal percarbonate in combination with a polyethylene glycol and polyvinylpyrrolidone.

To date, however, none of the approaches has always led in practice to satisfactory results. According to experience, colored and white textile products are generally still always washed separately.

On the other hand, carrier systems are frequently used in the medical and scientific sector. They have the function of transporting an incorporated active substance, for example a pharmacologically active substance, to a destination and of releasing it there. Ointments or sprays, for example, into which the active ingredient (for example an analgesic or an anti-allergic agent) is incorporated, are easy to handle. The active ingredient can thus be administered by means of the ointment or the spray in a gentle manner over the skin.

Analogously, carrier systems play an important role in the cosmetic sector. Substances of vegetable or synthetic origin, such as vitamins, fruit acids, plant extracts, antimicrobial agents or inflammation inhibitors, are released to the skin as ingredients by lotions, creams or face masks.

Especially in the cosmetic and in the medical sector, high requirements are placed on a carrier system.

A carrier system
must be toxically innocuous,
must not cause any irritations,
must bring the transported active substance undecomposed to its destination,
must release the active substance effectively at the destination and
should, if possible, facilitate the penetration of the active ingredient into the skin, reduce the penetration time and have a considerable positive influence on the penetration rate.

The last three points are of particularly great significance for the functioning of a carrier system. Firstly, a carrier system should easily take up the active ingredient and then be able to bind it firmly enough to prevent premature release and in order to stabilize it during prolonged storage. Secondly, an efficient carrier system must possess the property of easily and rapidly releasing the active ingredient to the target environment. Excessively strong binding between carrier system and transported active substance has an adverse effect on the release equilibrium.

Accordingly, it is an object of the invention, in particular, to develop new fields of use for the surfactants and, in doing so, to solve a maximum number of the problems outlined, especially in the field of washing and cleaning compositions, of cosmetics and pharmaceuticals. One focus of attention is on the provision of washing compositions with discoloration-inhibiting action.

This object is achieved by the subject-matter of the independent claims 1, 11 and 23. Preferred embodiments of the inventive use according to claim 1 are detailed in the dependent claims 2 to 10. Preferred embodiments of the inventive composition according to claim 11 are evident from dependent claims 12 to 22. Preferred embodiments of the inventive use according to claim 23 are defined in dependent claims 24 to 26. The wording of all claims is incorporated here by reference into the contents of this description.

One embodiment of such a solution has already been described in DE 41 18 440 A1, whose contents are incorporated here by reference. In the course of a process for determining lipase activity in foodstuffs, an aqueous solution buffered to a certain pH and comprising a nonionic surfactant (Triton® X-100, Triton® is a brand of Union Carbide) was used as an extraction solution in order to extract lipases present in a foodstuff sample.

It has now been found that, surprisingly, such a solution comprising alkylphenoxypolyethoxyethanol, preferably Triton® X-100, of the general formula 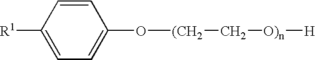
(R¹=straight-chain or branched alkyl group, preferably an isooctyl group, n is preferably 9 or 10)
also, beyond its original use, has outstanding properties, for example as a washing composition with discoloration-inhibiting action.

The alkylphenoxypolyethoxyethanol is present in the solution used in accordance with the invention in a fraction of up to 99.99% by volume, preferably between 0.1% by volume and 75% by volume, in particular between 0.5% by volume and 20% by volume.

The solution used in accordance with the invention is preferably buffered. The buffer used is preferably borax in conjunction with hydrochloric acid. The pH of the solution is preferably set between 7 and 10, in particular between 7 and 8. The solvent used is preferably water, but it is also possible to use other polar solvents such as alcohols, or for them to be present.

This invention also provides compositions of the abovementioned solution and at least one active substance, and for the use of these compositions.

Especially in combination with washing-active substances, surprising results were achieved. A composition of a solution which contains 2.5% by volume of Triton® X-100, is set to a pH of approx. 7-8 and has fractions of the discoloration inhibitor Sokalan® HP 56 (BASF AG, aqueous, 30% solution of a copolymer of 1-vinylimidazole and 1-vinyl-2-pyrrolidone in water) and Rimapur® CX (from Heinrich Rimml in Zurich, aqueous solution of a nitrogen-containing polymer) exhibited strong discoloration-inhibiting action when used as a washing composition. In test wash cycles both with synthetic and with natural textiles, no discoloration of the brighter laundry constituents could be detected.

Disadvantages and restrictions outlined at the outset in the case of simultaneous treatment of colored and white laundry do not occur in the case of the inventive use, especially not in the preferred embodiment with Sokalan® HP 56 and Rimapur® CX as further active substances.

Apart from the washing-active substances already mentioned, it is possible, additionally or instead, to use further active substances customary in the washing products industry, alone or in combination. These include softeners, bleaches, optical brighteners, complexing agents, enzymes, fragrances, textile softeners, discoloration inhibitors and stabilizers.

The inventive solution also finds use in the medical and in the cosmetic sector. In this case, the solution comprising the alkylphenoxypolyethoxyethanol assumes the function explained at the outset of a carrier system for further added active substances.

Thus, an aqueous solution, buffered with borax/hydrochloric acid, of Triton® X-100 and sodium N-chloro-p-toluenesulfonamide trihydrate (Chloramine-T) serves to disinfect wounds and to treat insect bites or pruritus, as occurs, for example, in the cause of neurodermitis or in the case of allergies. The solution can either be spread or sprayed onto the skin. In weaker concentration, it is also suitable for treating the mucus membrane in the oral/pharyngeal region in humans and animals. By virtue of inhalation through the mouth and nose, it is also possible to treat colds, nasal catarrhs, and disorders of the maxillary and nasal sinuses. The efficiency of many active pharmacological ingredients is enhanced when they are administered as part of the inventive solution. This might be attributable to the fact that the active substance can penetrate more easily into skin layers when it has been incorporated into the buffered Triton® X-100 solution. Owing to this property, it is possible to use the inventive solution in combination with an active substance, for example insulin, via a plaster.

A further medical application is the treatment of limb and joint pains. For this purpose, an inflammation-inhibiting substance, for example ibuprofen, is added to the Triton® X-100 solution. The composition is preferably sprayed onto the body part to be treated; it does not need to be massaged in for the penetration of the active ingredient.

A cosmetic composition is obtained by mixing the solution mentioned with pure aloe-vera extract at elevated temperature. A sprayable solution is obtained, which can be utilized both for regreasing various parts of the skin and for protecting from environmental influences. Analogously, the incorporation of active cosmetic ingredients such as vitamins, fruit acids, plant extracts, liposomes, ceramides, antimicrobial agents, glycerol, fats and oils, for example olive oil, is provided for.

Further features of the invention are evident from the description of preferred embodiments which follows in conjunction with the subclaims. The individual features may each be realised alone or in a plurality in combination with one another in one embodiment of the invention.

### EXAMPLES

An inventive solution with a content of 2.5% by volume of Triton® 100 was prepared as follows:

5.0 g of borax are dissolved with 2 g of 37% hydrochloric acid in 1000 ml of water. To this end, borax is first initially charged, hydrochloric acid is added and the mixture is heated with stirring to 45° C. With stirring, the full dissolution of the additives is awaited. Then, 25 ml of this solution are withdrawn with a pipette. While continuing to stir, Triton® X-100 is used to make up the remaining 975 ml back to a volume of 1000 ml. The mixture is stirred at 45° C. for a further 60 minutes.

This process was used to prepare solutions with a content of 0.1% by volume, 0.2% by volume, 1% by volume, 2% by volume, 5% by volume, 10% by volume and 25% by volume of Triton® X-100. To this end, an appropriate fraction of aqueous borax/hydrochloric acid solution was withdrawn in each case and replaced by the same volume of Triton® X-100. Buffered Triton® X-100 solutions of any concentration are prepared by this procedure.

Use as Washing Compositions

A particularly preferred washing composition has the following composition:
50% by volume of a solution of 2.5% by volume of Triton® X-100 and 97.5% by volume of a solution of 0.2% by weight of 37% hydrochloric acid, 0.5% by weight of borax and water.
15% by volume of Sokalan® HP 56 from BASF AG (aqueous, 30% solution of a copolymer of 1-vinylimidazole and 1-vinyl-2-pyrrolidone in water).
35% by volume of Rimapur® CX from Heinrich Rimml in Zurich (aqueous solution of a nitrogen-containing, nonionic polymer).

Using this washing composition, colored laundry was washed mixed with white laundry in a plurality of test cycles. No discoloration of the brighter laundry items was observed. Especially in the case of oil-containing stains, outstanding wash results were achieved.

A Triton® X-100 solution prepared by the above-described process can be used as a washing composition or as a washing composition additive without addition of active substances such as Rimapur® CX or Sokalan® HP 56. It possesses washing power-enhancing properties.

Triton® X-100 solutions and compositions are usable at all temperatures, i.e. both for manual washing and for washing operations at higher temperatures.

A further preferred washing composition has the following composition:
21.90% Sokalan® HP 53 from BASF AG
25.00% Sokalan® HP 56 from BASF AG
21.90% Sokalan® HP 59 from BASF AG
21.90% Sokalan® HP 60 from BASF AG
09.30% of an aqueous solution.

The aqueous solution consists of
9.00% dichloroisocyanurate,
45.50% water (purified) and
45.50% of a Triton® X-100 solution

In the formulation of the aqueous solution, it is advantageous first to initially charge the isocyanurate, to dissolve it with heated water and then to add the Triton® X-100 solution.

The Triton® X-100 solution consists of
24.00% Triton® X-100,
2.50% of borax,
1.00% of 37% hydrochloric acid and
72.50% water.

Use of this washing composition prevents dye leaching and resulting dye transfers in the course of washing. Outstanding test results were achieved when 200 ml of this washing composition were added to the main wash and 70 ml of the washing composition into the rinse cycle. It is assumed that a protective layer forms on the fabric and, secondly, dye residues are taken up into the solution and transported away.

Medical Use

Solutions described in accordance with the invention and having different concentrations of Triton® X-100, prepared by the process outlined above, find use in the medical sector. In this case, they comprise further active substances. The solutions are preferably sprayed on, but may also be spread on depending on the field of use.

| Content of Triton ® | Content of further active substance and |
|---|---|
| X-100 in % by volume | particular field of application |
| 2 | Content of Chloramine-T: from 0.5% by |
| | weight of 5% by weight: |
| | For wound disinfection in the case of |
| | relatively deep and large-surface wounds |
| 1 | Content of Chloramine-T: from 0.5% by |
| | weight to 2% by weight: |
| | For wound disinfection in the case of |
| | surface and relatively small wounds. |
| | Content of Chloramine-T: from 0.5% by |
| | weight to 1% by weight: |
| | For treatment of insect bites, for reducing |
| | swelling and for suppressing pruritis. |
| 0.2 | Content of Chloramine-T: from 0.5% by |
| | weight to 1% by weight: |
| | In the event of injuries to mucus membranes |
| | in the oral/pharyngeal region in humans and |
| | animals |
| 0.1 | Content of Chloramine-T: from 0.5% by |
| | weight to 1% by weight: |
| | For inhalation through mouth and nose in the |
| | event of nasal catarrhs, colds, disorders of |
| | the maxillary and paranasal sinuses |
| 1 | 100 ml of the solution containing 1% by |
| | volume of Triton ® X-100 contain 800 mg of |
| | ibuprofen: |
| | For treatment in the case of joint pains. |

Cosmetic Use

Solutions described in accordance with the invention with different concentrations of Triton® X-100 find use in the cosmetic sector. In this case, they comprise further active substances. The solutions can be sprayed on or spread on.

100 ml of a solution which contains 2% by volume of Triton® X-100 and has been prepared by the above process are mixed with 20 ml of pure olive oil. The mixing is effected with stirring at a temperature of 70-80° C. This forms a stable emulsion. The sprayable solution can be used for regreasing various parts of the skin.

100 ml of a solution which contains 1% by volume of Triton® X-100 and has been prepared by the above process are mixed with 30 ml of pure Aloe Vera extract. The mixing is effected with stirring at a temperature of 37-42° C. The sprayable solution can be used for regressing various parts of the skin and for protecting from environmental influences.

Use as a Degreasing and Cleaning Solution

A solution which contains 25% by volume of Triton® X-100 and has been prepared by the above-described process is heated to 60-80° C. This degreasing solution is sprayed on to the metal parts to be degreased. The grease is absorbed fully. The grease-containing, still-warm solution can be collected; in the course of cooling of the solution, the grease separates out again at least partly. The degreasing solution can thus be used more than once. This solution can be used, for example, to treat tools or metal surfaces, for example in the automobile industry or else in heavy industry.

A solution which preferably contains 10% by volume of Triton® X-100, which has again been prepared by the process outlined above, can be used particularly advantageously for removing fats and oils from polluted soils and/or other wastes.

In spraying processes, the solution containing 10% by volume of Triton® X-100 is also suitable for binding dusts, for example in the course of air cleaning in ultra-clean rooms.

What is claimed is:

1. The use of a solution composed of at least one solvent and at least one nonionic surfactant as a carrier system for at least one active substance.

2. The use as claimed in claim 1, characterized in that the nonionic surfactant is an alkylphenoxypolyethoxyethanol of the general formula 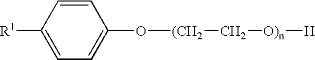
in which R¹ is a straight-chain or branched alkyl group, preferably an isooctyl group, and n is preferably 9 or 10.

3. The use as claimed in claim 2, characterized in that the nonionic surfactant is present in the solution in a fraction of up to 99.99% by volume, preferably between 0.1% by volume and 75% by volume, in particular between 0.5% by volume and 20% by volume.

4. The use as claimed in claim 3, characterized in that the solution is buffered and the pH of the solution is set between 7 and 10, in particular between 7 and 8.

5. The use as claimed in claim 4, characterized in that the solvent is a polar solvent, in particular water.

6. The use as claimed in claim 5, characterized in that the active substance is a washing-active substance, in particular an ionic or a nonionic surfactant.

7. The use as claimed in claim 6, characterized in that the active substance is a washing composition additive which is preferably selected from the group comprising softeners, bleaches, optical brighteners, complexing agents, enzymes, fragrances, textile softeners and discoloration inhibitors.

8. The use as claimed in one of claim 5, characterized in that the active substance is a cosmetic active ingredient which is selected from the group comprising vitamins, fruit acids, plant extracts, vegetable fats, vegetable oils, liposomes, ceramides, antimicrobial agents, glycerol and inflammation inhibitors.

9. The use as claimed in one of claim 5, characterized in that the active substance is a pharmaceutical active ingredient, in particular selected from the group comprising analgesics, antiallergics and inflammation inhibitors.

10. The use as claimed in one of claim 5, characterized in that the active substance is a disinfectant.

11. A composition comprising:
a carrier system, preferably in the form of a solution composed of at least one nonionic surfactant in a fraction of up to 99.99% by volume, in particular between 0.1% by volume and 75% by volume, and at least one polar solvent, in particular water,
at least one active substance.

12. The composition as claimed in claim 11, characterized in that the nonionic surfactant in the carrier system is an alkylphenoxypolyethoxyethanol of the general formula 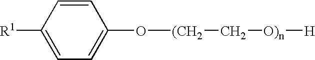
in which R¹ is a straight-chain or branched alkyl group, preferably an isooctyl group, and n is preferably 9 or 10.

13. The composition as claimed in claim 11, characterized in that the carrier system is buffered and the pH of the carrier system is set between 7 and 10, in particular between 7 and 8.

14. The composition as claimed in claim 11, characterized in that the active substance is a washing-active substance, in particular an ionic or a nonionic surfactant.

15. The composition as claimed in claim 11, characterized in that the active substance present is a washing composition additive which is preferably selected from the group comprising softeners, bleaches, optical brighteners, complexing agents, enzymes, fragrances, textile softeners, and discoloration inhibitors.

16. The composition as claimed in claim 11, characterized in that active substance present is a cosmetic active ingredient selected from the group comprising vitamins, fruit acids, plant extracts, vegetable fats, vegetable oils, liposomes, ceramides, antimicrobial agents, glycerol and inflammation inhibitors.

17. The composition as claimed in claim 16, characterized in that the cosmetic active ingredient is present in a concentration of up to 30% by weight, preferably of up to 10% by weight.

18. The composition as claimed in claim 11, characterized in that the active substance present is a pharmaceutical active ingredient, in particular selected from the group comprising analgesics, antiallergics, and inflammation inhibitors.

19. The composition as claimed in claim 11, characterized in that the active substance present is a disinfectant.

20. The composition as claimed in claim 18, characterized in that the active substance is present in the composition in a concentration of up to 30% by weight, preferably up to 10% by weight.

21. The composition as claimed in claim 11, comprising:
0.1-25% by weight of an alkylphenoxypolyethoxyethanol of the formula I,
0.1-50% by weight of at least one surfactant,
1-70% by weight of at least one discoloration inhibitor,
optionally washing composition additives such as softeners, bleaches, optical brighteners, complexing agents, enzymes, fragrances and/or textile softeners and
optionally, as the remainder, at least one polar solvent, in particular water.

22. The composition as claimed in claim 21, consisting of:
from 40% by volume to 60% by volume, preferably 50% by volume of a carrier system consisting of 2.5% by volume of isooctylphenoxypolyethoxyethanol and 97.5% by volume of a solution composed of 0.2% by weight of 37% hydrochloric acid, 0.5% by weight borax and water,
from 10% by volume to 20% by volume, preferably 15% by volume of Sokalan* HP 56 from BASF AG (aqueous, 30% solution of a copolymer of 1-vinylimidazole and 1-vinyl-2-pyrrolidone in water),
from 30% by volume to 40% by volume, preferably 35% by volume of Rimapur CX from Henrich Rimml in Zurich (aqueous solution of a nitrogen-containing polymer).

23. The use of a solution composed of at least one solvent and at least one alkylphenoxylpolyethoxyethanol of the general formula 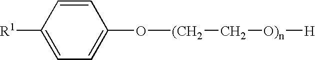
In which R¹ is a straight-chain or branched alkyl group, preferably an isooctyl group, and n is preferably 9or 10,

24. The use as claimed in claim 23, characterized in that the alkylphenoxypolyethoxyethanol is present in the solution in a fraction of up to 99.99% by volume, preferably between 0.1% by volume and 75% by volume, in particular between 0.5% by volume and 20% by volume.

25. The use as claimed in claim 23, characterized in that the solution is buffered and the pH of the solution is set between 7 and 10, in particular between 7 and 8.

26. The use as claimed in claim 23, characterized in that the solvent is a polar solvent, in particular water.
